(19) United States
(12) Patent Application Publication
(10) Pub. No.: US 2026/0015691 A1
(43) Pub. Date: Jan. 15, 2026

(54) METHODS OF MAKING UPGRADED SYNTHETIC RUTILE

(71) Applicant: University of Utah Research Foundation, Salt Lake City, UT (US)

(72) Inventors: Pei SUN, Salt Lake City, UT (US); Zhigang Z. FANG, Salt Lake City, UT (US); Nick ENGSTROM, Salt Lake City, UT (US)

(21) Appl. No.: 18/993,819

(22) PCT Filed: Jul. 12, 2023
(86) PCT No.: PCT/US2023/027548

§ 371 Date: Jan. 13, 2025

Related U.S. Application Data
(60) Provisional application No. 63/388,328, filed on Jul. 12, 2022.
(60) Provisional application No. 63/392,882, filed on Jul. 28, 2022.

(51) Int. Cl. C22B 34/12; C01G 23/047; C22B 1/16; C22B 1/24; C22B 1/244; C22B 3/04

(52) U.S. Cl. CPC C22B 34/1213; C01G 23/047; C22B 1/16; C22B 1/2406; C22B 1/244; C22B 3/04; C22B 34/1245; C22B 34/125; C01P 2004/60

(57) ABSTRACT

A method of making upgraded synthetic rutile (100) can include binding ilmenite ultrafine particles together with a binder to form green pellets (110). Iron can be reduced in the green pellets by heating the green pellets to a reducing temperature under a reducing atmosphere (120). The ilmenite ultrafine particles within the green pellets can be at least partially sintered together by heating the green pellets at a sintering temperature to form at least partially sintered pellets (130). Iron can be removed from the at least partially sintered pellets by leaching to form upgraded synthetic rutile (140).

### CROSS REFERENCE TO RELATED APPLICATIONS

This application claim priority to U.S. Provisional Application No. 63/388,328, filed Jul. 12, 2022, and U.S. Provisional Application No. 63/392,882, filed Jul. 28, 2022, both of which are incorporated herein by reference.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION BY REFERENCE STATEMENT

Not applicable.

### BACKGROUND

Ilmenite is the most common titanium-bearing mineral in the earth's crust, with a TiO₂ content ranging from 40-65 wt % after concentration from hard rock or sand deposits. The majority of ilmenite is used for producing pigment (TiO₂) via well-known sulfate or chloride processes. The chloride process has less environmental impact than the sulfate process, so it is preferred by the industry. However, the chloride process using a fluidized bed reactor generally utilizes a feedstock containing high TiO₂ content (>88 wt %) and coarse particles (>75 μm). To produce the material with >88% of TiO₂, a hydrometallurgical process, such as the Becher process is used to upgrade ilmenite to synthetic rutile.

Ilmenite is a naturally occurring ore that includes iron and titanium oxide, with the general chemical formula FeTiO₃. There are numerous industrial processes for upgrading ilmenite to rutile with ˜90 wt % TiO₂. Some processes for industrial production of synthetic rutile include two primary steps: 1) solid-state reduction of ilmenite to form Fe²⁺ or Fe metal, and 2) leaching out the reduced iron element to improve the TiO₂ content. Some examples of these upgrading processes include: the Becher process, the Benelite process, the Ishihara process, the Laporte process, etc. However, these processes cannot coarsen the feed materials, so the rutile synthesized from fine ilmenite through these processes cannot be used in fluidized bed chlorination reactors. In order to make coarse synthetic rutile from fine ilmenite, the Tyssedal process was developed. In this process, coarse or fine ilmenite ore is milled into ultrafine particles, and then pelletize with coal and bentonite to large pellets (˜10 mm diameter) by a rotating drum. The pellets are sintered at 850-900° C., and then pre-reduced by coal in a rotary kiln at ˜1100-1200° C. After the pre-reduction, the pellets are fed into an electric furnace for smelting. During smelting, the iron is removed as liquid metal, leaving high-titanium bearing slag behind. The slag is crushed to desired particle size for the chloride process.

The Tyssedal process can be used to produce coarse synthetic rutile for the chloride process for the production of pigment. However, the energy consumption and the production cost are high. Also, this process uses carbon as the reducing agent, so the carbon emission is also high.

### SUMMARY

The present disclosure describes methods of making upgraded synthetic rutile. In some examples, a method of making upgraded synthetic rutile can include binding ilmenite ultrafine particles together with an optional binder to form green pellets. The method can then include reducing iron in the green pellets by heating the green pellets to a reducing temperature under a reducing atmosphere. The ilmenite ultrafine particles within the green pellets can be at least partially sintered together by heating the green pellets at a sintering temperature to form at least partially sintered pellets. The method can also include removing iron from the at least partially sintered pellets by leaching to form upgraded synthetic rutile.

Additional features and advantages of these principles will be apparent from the following detailed description, which illustrates, by way of example, features of the invention.

### BRIEF DESCRIPTION OF THE DRAWINGS

FIG. 1 is a flow diagram of a method of making upgraded synthetic rutile in accordance with one example.

FIG. 2 is a scanning electron micrograph of fine ilmenite particles that can be used as a starting material in example methods in accordance with the present disclosure.

FIG. 3 is a schematic illustration of ultrafine ilmenite particles in accordance with an example of the present disclosure.

FIG. 4 is a schematic illustration of green pellets in accordance with an example of the present disclosure.

FIG. 5 is a schematic illustration of partially sintered pellets in accordance with an example of the present disclosure.

FIG. 6 is a scanning electron micrograph of upgraded synthetic rutile in accordance with an example of the present disclosure.

These drawings are provided to illustrate various aspects of the invention and are not intended to be limiting of the scope in terms of dimensions, materials, configurations, arrangements or proportions unless otherwise limited by the claims.

### DETAILED DESCRIPTION

Reference will now be made to exemplary embodiments and specific language will be used herein to describe the same. It will nevertheless be understood that no limitation of the scope of the invention is thereby intended. Alterations and further modifications of the inventive features described herein, and additional applications of the principles of the invention as described herein, are to be considered within the scope of the invention. Further, before particular embodiments are disclosed and described, it is to be understood that this invention is not limited to the particular process and materials disclosed herein as such may vary to some degree. It is also to be understood that the terminology used herein is used for the purpose of describing particular embodiments only and is not intended to be limiting, as the scope of the present invention will be defined only by the appended claims and equivalents thereof.

### Definitions

In describing and claiming the present invention, the following terminology will be used.

The singular forms “a,” “an,” and “the” include plural references unless the context clearly dictates otherwise. Thus, for example, reference to “a pellet” includes reference to one or more of such structures, “a metal” includes reference to one or more of such materials, and “a heating step” refers to one or more of such steps.

As used herein, “substantial” when used in reference to a quantity or amount of a material, or a specific characteristic or property thereof, refers to an amount or property value that is sufficient to provide an effect that the material or property was intended to provide. The exact degree of deviation allowable may in some cases depend on the specific context. Similarly, “substantially free of” or the like refers to the lack of an identified element or agent in a composition. Particularly, elements that are identified as being “substantially free of” are either completely absent from the composition, or are included only in amounts which are small enough so as to have no measurable effect on the composition.

As used herein, “about” refers to a degree of deviation based on experimental error typical for the particular property identified. The latitude provided the term “about” will depend on the specific context and particular property. The term “about” is not intended to either expand or limit the degree of equivalents which may otherwise be afforded a particular value. Further, unless otherwise stated, the term “about” shall expressly include “exactly,” consistent with the discussion below regarding ranges and numerical data. However, unless otherwise enunciated, the term “about” generally connotes flexibility of less than 2%, most often less than 0.5%, and in some cases less than 0.01%.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a range of about 1 to about 200 should be interpreted to include not only the explicitly recited limits of 1 and 200, but also to include individual sizes such as 2, 3, 4, and sub-ranges such as 10 to 50, 20 to 100, etc.

As used herein, the term “at least one of” is intended to be synonymous with “one or more of.” For example, “at least one of A, B and C” explicitly includes only A, only B, only C, and combinations of each.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

### Methods of Making Upgraded Synthetic Rutile

The methods described herein provide a way to produce upgraded synthetic rutile, which can contain rutile and/or anatase, and which are the appropriate size to be used as a feedstock for the chloride process of producing titanium dioxide pigment. These methods can consume less energy than other methods of converting ilmenite to synthetic rutile, and the methods can also have much lower carbon emissions. As used herein, “upgraded synthetic rutile” refers to a titanium rich material which contains at least 75 wt % of TiO₂. Upgraded synthetic rutile can be an upgraded ilmenite or other upgraded titanium-containing mineral and is often in the form of titanium dioxide pellets.

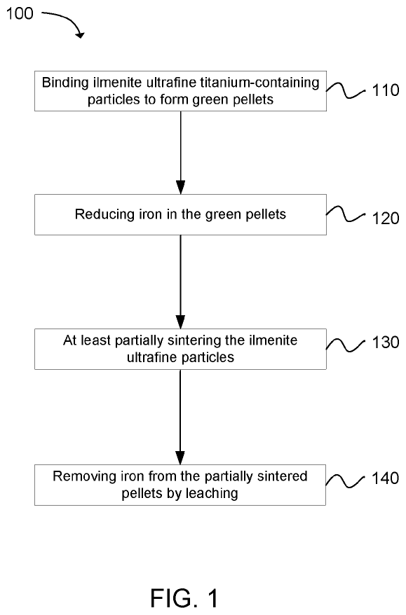

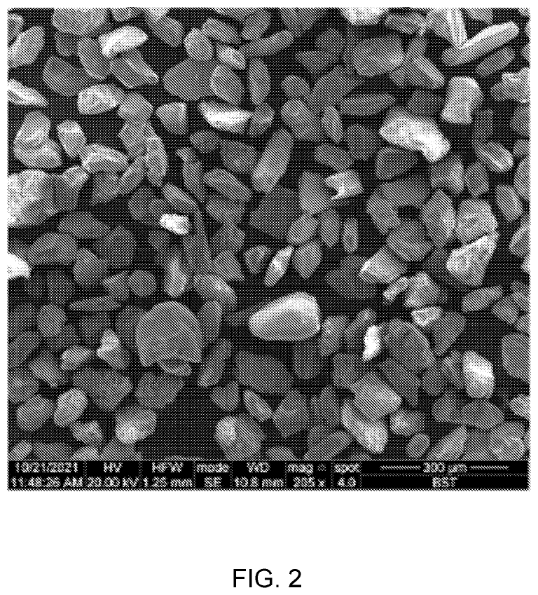

FIG. 1 shows a method 100 of making upgraded synthetic rutile from ilmenite titanium-containing particles. The starting material for the methods described herein can include ilmenite ore, which can contain titanium dioxide in an amount from about 40 wt % to about 65 wt % and iron in an amount from about 15 wt % to about 31 wt %. The ilmenite ore can have an initial particle size that varies depending on the particular form of the natural ore deposits where the ore is mined. Some ore deposits can contain many fine particles of ilmenite. In certain examples, the ilmenite starting material can have an average particle size of less than 150 micrometers. FIG. 2 is an electron micrograph showing fine ilmenite ore particles that were mined for used as the starting material for an example method of making upgraded synthetic rutile as described herein.

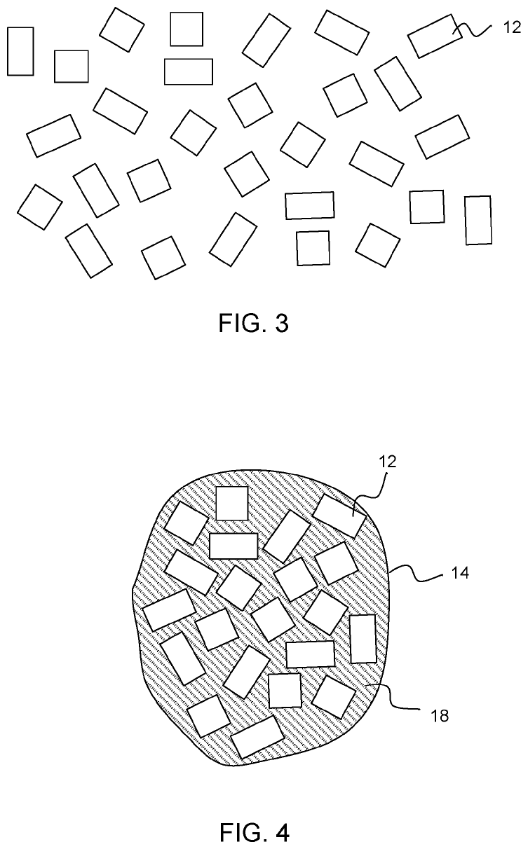

In some examples, ilmenite ore can be milled to form ultrafine ilmenite particles having an average particle size less than 10 micrometers. In certain examples, the average particle size can be from 0.1 micrometer to 50 micrometers, and in other cases from 0.1 to 10 micrometers. Milling can be performed, for example, by ball milling with water and ¼ inch stainless steel balls. After milling the ilmenite ore to ultrafine particles, the ultrafine particles can be dried. In alternative examples, ultrafine ilmenite particles can be obtained in a different way. For example, ultrafine ilmenite particles can be pulverized, roller milled, hammer milled, multi-stage grinding, multi-cracker milling, sieving, jet milling, cryogenic milling, and the like. FIG. 3 shows an idealized example of ilmenite ultrafine particles 12. Note that the particles are loose and flow independent of one another at this stage. The ilmenite ultrafine particles also tend to be varied in shape and exhibit a particle size distribution.

The ultrafine ilmenite particles can be pelletized. Pelletizing can be performed by binding the ilmenite ultrafine particles together with a binder. Referring to FIG. 1, the ilmenite ultrafine titanium-containing particles can be binded together using an optional binder to form green pellets 110. The binder can be an organic binder or inorganic binder in various examples. Organic or inorganic binders can be used which dissolve in a corresponding solvent, hold ultrafine particles together, and thermally decompose. However, in some examples the binder can be an organic binder. In choosing an organic binder, it is desirable to choose a binder that does not leave undesirable residue during debinding. Suitable binders can also provide sufficient strength to the green pellets during handling and up through sintering, while also avoiding undesirable residual decomposition products during heating and sintering. In some cases, an inorganic binder such as silica, alumina, or the like can be used with some residual impurities left upon debinding which are acceptable in certain applications. The organic binder can include, but is not limited to, polyethylene, polypropylene, polyethylene glycol, polyvinylpyrrolidone, polyoxymethylene, polylactic acid, nylon, hyaluronate, cellulose, starches, or a combination thereof. The binder can sometimes be applied to the ultrafine ilmenite particles in the form of a solution that can be mixed with the particles and then dried. Binding the ilmenite ultrafine particles together can be accomplished by spraying a solution of the binder while tumbling the ultrafine ilmenite particles in a rotating vessel. The solution can include a solvent and the binder in an amount from about 0.1 wt % to about 5 wt %, for example. The solvent can include any solvent that dissolves the organic binder. The solution of the organic binder can include the organic binder dissolved in a solvent such as, but not limited to, ethanol, methanol, water, heptane, benzene, isopropyl alcohol, butanol, acetone, or a combination thereof. The binder and ultrafine ilmenite particles can be mixed to form pellets having an average pellet size from about 100 micrometers to about 1500 micrometers, and in some cases 75 micrometers to about 1000 micrometers.

In one specific example, dry ultrafine particles are loaded into a rotating tilted drum or disc (e.g. disc pelletizer) first, and then ethanol with dissolved polyvinylpyrrolidone (100 ml:1 g) is sprayed onto the spinning powder bed. After that, the ultrafine particles will start snowballing to large pellets. The solution can be dosed multiple times until desired particles size is obtained. After drying, the green pellets are sieved with a 100 mesh sieve (149 μm) and a 16 mesh sieve (1.19 mm). The −100 mesh pellets and +16 mesh pellets (after crushing) are returned to the rotating bottle to pelletize with milled fine ilmenite particles again. FIG. 4 shows an example of a green pellet 14 that includes many ultrafine ilmenite particles 12 bound together with a binder 18. Other pelletizing processes can be used such as, but not limited to, spray drying, compression, straight grate pelletizing, and the like.

Referring again to FIG. 1, iron in the green pellets can be reduced by heating the green pellets under a reducing atmosphere 120, followed by at least partially sintering the pellets by heating the pellets to a sintering temperature 130. The reduction can be performed by heating the green pellets to a reducing temperature for a reducing time. The reducing temperature can be from about 400° C. to about 1000° C. in some examples, and from 700° C. to 1000° C. in other examples. The reducing time can be from about 0.1 hours to about 16 hours, and in some cases less than 16 hours, and in some cases from 2 to 16 hours, depending on the batch size, particle sizes, and temperature. The organic binder can be vaporized or decomposed when the temperature of the pellets is ramped up to the reducing temperature, and/or while the temperature is held at the reducing temperature for the reducing time. The reducing atmosphere can include hydrogen gas or consist of hydrogen gas. In some examples, the reducing atmosphere can be free of carbon and optionally no carbon is added when forming the green pellets other than organic binder. However, carbon can be included in the reducing atmosphere in some examples if desired. Examples of gases that can be included in the reducing atmosphere include hydrogen, methane, carbon monoxide, and combinations thereof. In other cases, an inert gas such argon and/or nitrogen is optionally included with hydrogen gas Such inert gases can act as a carrier gas and to control hydrogen concentrations. Additionally, in some examples no carbon is added to the ilmenite as a reducing agent. A small amount of carbon can be present in the form of the organic binder, but the pellets can be free of carbon other than the organic binder. The reducing atmosphere can also be achieved using carbon monoxide (CO) or ammonia gases and mixtures thereof. However, hydrogen is an environmentally benign gas and can often be a desirable choice. The at least partially sintering can also be performed under the reducing atmosphere. The hydrogen atmosphere can be maintained throughout the reduction and sintering cycle. In some cases, inert atmosphere such as argon or nitrogen gas may be used when the reduction of iron oxides is complete.

In one specific example, the green pellets in the sieve cut of −16/+100 mesh are loaded into a tube furnace for reduction and sintering. The reduction and sintering are carried out in flowing hydrogen. Before the reduction happens, the binder (e.g. polyvinylpyrrolidone) will leave the pellets through vaporization and thermal decomposition in the temperature range of 200-450° C. In this example, the furnace is held at 750° C. for 8 hours for the completion of reduction. The following reaction happens during the reduction:

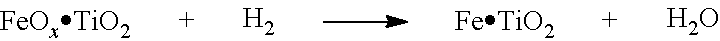

Iron metal is formed from the reduction as shown above.

After reduction, the temperature is ramped up to a sintering temperature to at least partially sinter the ilmenite ultrafine particles within the pellets. In further examples, the sintering temperature can be greater than the reducing temperature. The green pellets can be heated from the reducing temperature to the sintering temperature without cooling the green pellets below the reducing temperature in between. As used herein “partially sintering” refers to sintering to a sufficient degree that the ultrafine particles are welded/joined together at contact points between the particles, but where a majority of the original void space between the particles still remains after the partial sintering. Thus, the pellets can retain their shape after partial sintering but the pellets can have a high porosity due to the void space that remains in the pellets. The partial sintering can be performed by increasing the temperature of the pellets from the reducing temperature to the sintering temperature without cooling the pellets in between. In other examples, the partial sintering can be performed by increasing the temperature of the pellets to the sintering temperature after letting the pellets cool from the reducing temperature. In this manner, the materials can be stored or provided with intermediate processing. Further, in some examples, such a two stage heating process can allow for the high temperature sintering under nitrogen atmosphere. An increased production rate and lower cost may be achieved by using one low temperature furnace for hydrogen reduction and another separate furnace for sintering under nitrogen, for example.

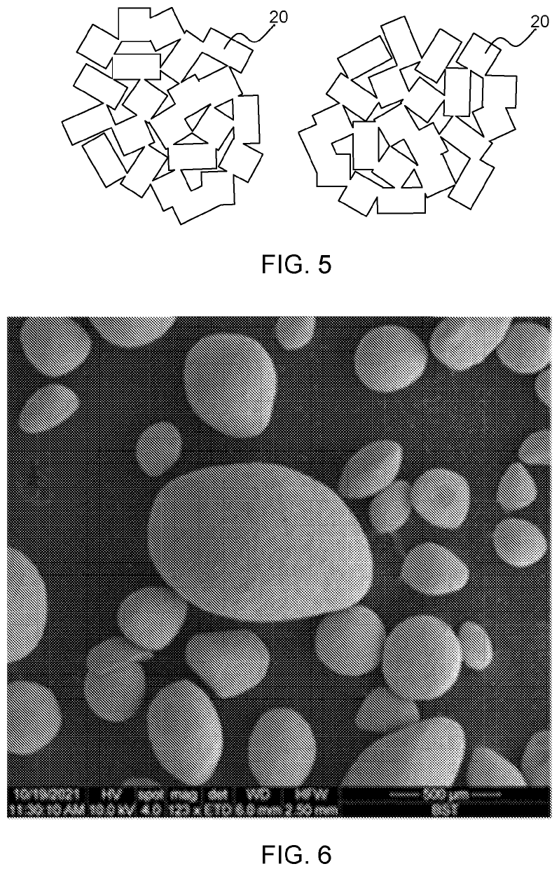

In some examples, the at least partial sintering can also be performed under the reducing atmosphere while holding at the sintering temperature for a sintering time. As a general guideline, the sintering temperature can be from about 900° C. to about 1400° C. and the sintering time can be from about 10 minutes to about 2 hours. In some cases, the sintering temperature can exceed 1400° C. (e.g. up to about 1500° C.) as long as iron metal is not melted. In one specific example, the temperature of the reduced pellets can be ramped up to 1000° C. and held at the temperature for 30 minutes to partially sinter the ultrafine particles within the pellets. In some examples, the at least partially sintering can be partially sintering the ilmenite ultrafine particles so that at least some void space between the ilmenite ultrafine particles remains in the at least partially sintered pellets. Regardless, the partially sintered pellets can have sufficient strength to retain their shape when used as a feedstock in a fluidized bed reactor, such as the reactors used in the chloride process for purifying titanium dioxide. FIG. 5 shows an example of partially sintered pellets 20.

Referring again to FIG. 1, after the pellets have been at least partially sintered, iron can be removed from the pellets by leaching 140. For example, the iron in the pellets can be dissolved with hydrochloric acid, sulfuric acid, aeration with ammonium chloride, or with another leaching agent. As a general guideline, suitable leaching agents can be safe to handle, capable of recycling using acid, and easily disposable. In some cases, dilute HCl solutions can be used in leaching. For example, concentrations from 0.001 to 2 mol/L, and in some cases up to about I mol/L HCl. Leaching temperature can also be varied to adjust leaching kinetics.

After the iron has been removed, the pellets can have a high concentration of titanium dioxide, such as greater than 88 wt %. The final upgraded synthetic rutile can include rutile, anatase, or a combination thereof. Thus, in some examples the concentration of acid and/or the temperature during leaching can be controlled to control the crystal structure of the final pellets. Depending on the leaching agent used, the leaching process can produce hydrogen gas (e.g. if the leaching agent contains hydrogen). Thus, the method can also include capturing and recycling the hydrogen gas to a reducing atmosphere used during reducing iron in a subsequent batch of green pellets, and optionally also during sintering.

In one specific example, reduced and sintered pellets are added into excess 1 mol/L HCl acid to leach out the iron metal in the pellets. The pellets are left in the acid for 4 hours, and then are rinsed for five times to eliminate FeCl₂ formed during leaching. After rinsing, the pellets are dried at 80° C. The following reaction happens during the reduction:

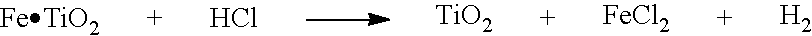

The pellets after the above-discussed process have a TiO₂ content higher than 90%, and the particle size range from 100 μm to 1000 μm, which can be used as the feedstock for the fluidized bed chlorination reactors. The final rutile pellets have a highly porous structure, which improves the chlorination kinetics in later processing. The concentration during leaching, or the temperature during leaching, or both can be varied to control the crystal structure of the upgraded synthetic rutile.

In comparison to other processes for making titanium dioxide feedstocks for the chlorination process, the methods described herein can provide reduced energy consumption and reduced carbon emissions. For example, the Tyssedal process includes three high temperature steps (sintering, pre-reduction and smelting). It uses carbon as the reducing agent, so it has a high energy consumption and carbon emission. In comparison, the methods described herein include one high-temperature step by combining sintering and reduction in one heating run. In addition, hydrogen can be used as the reducing agent to minimize the carbon footprint. Therefore, the methods described herein can be more energy- and cost-efficient than the Tyssedal process, with less carbon footprint. The upgraded synthetic rutile produced using the methods described herein can also have a high porosity, which can increase the kinetics of the chlorination process. The porosity of the upgraded synthetic rutile can be less than 50%, and in some cases 5 to 20% by volume. The upgraded synthetic rutile can include titanium dioxide, in an amount greater than 88 wt %, in some cases greater than 90 wt % and in other cases greater than 92 wt %. In various examples, the upgraded synthetic rutile can include rutile, anatase, or a combination thereof. The upgraded synthetic rutile can have an average particle size from about 75 μm to 2 mm, and in some cases 100 μm to about 1000 μm.

The present disclosure also describes upgraded synthetic rutile. In some examples, the upgraded synthetic rutile can include comprising a plurality of partially sintered together ultrafine particles. The ultrafine particles can have an average particle size from about 1 μm to about 10 μm, and void spaces are present between at least some of the partially sintered together ultrafine particles. The upgraded synthetic rutile can have a diameter from about 100 μm to about 1000 μm. In some examples, the upgraded synthetic titanium dioxide pellet can be free of inorganic binder. In some cases, the green pellets can be formed without the use of a binder.

Additional operations can also be added to the methods described above. In some examples, the ultrafine ilmenite particles can be pre-oxidized before the reduction. The pre-oxidation can convert iron(II) to iron (III). This pre-oxidation can be performed before pelletizing the ilmenite ultrafine particles or after pelletizing the ilmenite ultrafine particles. In other examples, iron that is removed during leaching can be recovered and used or sold as a product. In further examples, the methods can also include using the final upgraded synthetic rutile as a feedstock material for a fluidized bed reactor, such as in a chlorination process of purifying titanium dioxide.

### Working Example

Fine ilmenite particles (<150 μm) were milled with water and ¼″ stainless-steel balls to ultrafine particles (<10 μm), and then dried at room temperature. The dry ultrafine particles were loaded into a rotating tilted drum first, and then ethanol with dissolved polyvinylpyrrolidone (100 ml:1 g) was sprayed onto the spinning powder bed. After that, the ultrafine particles started snowballing to large pellets. The solution was sprayed multiple times until the desired particles size was obtained. After drying, the green pellets were sieved with a 100 mesh sieve (149 μm) and a 16 mesh sieve (1.19 mm). The −100 mesh pellets and +16 mesh pellets (after crushing) were returned to the rotating bottle to pelletize with milled fine ilmenite particles again.

The green pellets in the sieve cut of −16/+100 mesh were loaded into a tube furnace for reduction and sintering. The reduction and sintering were carried out in flowing hydrogen. Before the reduction, the binder (polyvinylpyrrolidone) leaves the pellets through vaporization and thermal decomposition in the temperature range of 200-450° C. The furnace was then held at 750° C. for 8 hours for the completion of reduction.

After the reduction, the temperature was ramped up to 1000° C. and held at that temperature for 30 minutes to partially sinter the ultrafine particles within the pellets for obtaining enough strength.

The reduced and sintered pellets were added into excess 1 mol/L HCl acid to leach out the iron metal in the pellets. The pellets were left in the acid for 4 hours, and then rinsed for five times to eliminate FeCl₂ formed during leaching. After rinsing, the pellets were dried at 80° C.

The final pellets after the above-discussed process had a TiO₂ content higher than 90%, and a particle size range from 100 μm to 1000 μm. The pellets can be used as the feedstock for the fluidized bed chlorination reactors. The final pellets had a highly porous structure, which can improve the chlorination kinetics. FIG. 6 is a scanning electron micrograph of the final upgraded synthetic rutile.

### CLAUSES

For purposes of clarity, additional variations of the method of making upgraded synthetic rutile can include
Clause 1: A method of making upgraded synthetic rutile, comprising:
binding ilmenite ultrafine titanium-containing particles together with an optional binder to form green pellets;
reducing iron in the green pellets by heating the green pellets to a reducing temperature under a reducing atmosphere;
at least partially sintering together the ilmenite ultrafine particles within the green pellets by heating the green pellets at a sintering temperature to form at least partially sintered pellets; and
removing iron from the at least partially sintered pellets by leaching to form upgraded synthetic rutile.
Clause 2: The method of claim 1, further comprising forming the ilmenite ultrafine particles by milling ilmenite ore.
Clause 3: The method of claim 1, wherein the ilmenite ultrafine particles have an average particle size from about 0.1 micrometer to about 10 micrometers.
Clause 4: The method of claim 1, wherein the ilmenite ultrafine particles include titanium dioxide in an amount from about 40 wt % to about 65 wt % and iron in an amount from about 15 wt % to about 31 wt %.
Clause 5: The method of claim 1, wherein the optional binder is an organic binder.
Clause 6: The method of claim 5, wherein the organic binder comprises polyethylene, polypropylene, polyethylene glycol, polyvinylpyrrolidone, polyoxymethylene, polylactic acid, nylon, hyaluronate, cellulose, starches, or a combination thereof.
Clause 7: The method of claim 5, wherein binding the ilmenite ultrafine particles together comprises spraying a solution of the organic binder while tumbling the ultrafine ilmenite particles in a rotating vessel.
Clause 8: The method of claim 7, wherein the solution of the organic binder includes the organic binder dissolved in a solvent comprising ethanol, methanol, water, or a combination thereof.
Clause 9: The method of claim 7, wherein the concentration of organic binder in the solution is from about 0.1 wt % to about 5 wt %.
Clause 10: The method of claim 5, wherein the organic binder is vaporized or decomposed during the heating the green pellets to the reducing temperature.
Clause 11: The method of claim 5, wherein no carbon is added to the ilmenite ultrafine particles when forming the green pellets other than the organic binder.
Clause 12: The method of claim 1, wherein the green pellets have an average particle size from about 100 μm to about 1500 μm.
Clause 13: The method of claim 1, wherein the reducing temperature is from about 400° C. to about 1000° C.
Clause 14: The method of claim 1, wherein reducing the iron in the green pellets comprises holding the green pellets at the reducing temperature for a reducing time from about 0.1 hours to about 16 hours.
Clause 15: The method of claim 1, wherein the reducing atmosphere is hydrogen gas. Clause 16: The method of claim 1, wherein the at least partially sintering is performed under the reducing atmosphere.
Clause 17: The method of claim 1, wherein the sintering temperature is greater than the reducing temperature.
Clause 18: The method of claim 17, wherein the green pellets are heated from the reducing temperature to the sintering temperature without cooling the green pellets below the reducing temperature in between.
Clause 19: The method of claim 17, wherein the green pellets are heated to the sintering temperature after letting the green pellets cool below the reducing temperature.
Clause 20: The method of claim 1, wherein the sintering temperature is from about 900° C. to about 1500° C.
Clause 21: The method of claim 1, wherein the at least partially sintering comprises holding the green pellets at the sintering temperature for a sintering time from about 10 minutes to about 2 hours.
Clause 22: The method of claim 1, wherein the at least partially sintering is partially sintering the ilmenite ultrafine particles so that at least some void space between the ilmenite ultrafine particles remains in the at least partially sintered pellets.
Clause 23: The method of claim 1, wherein leaching includes dissolving the iron with hydrochloric acid, sulfuric acid, or by aeration with ammonium chloride, and optionally using a dilute acid concentration.
Clause 24: The method of claim 23, wherein hydrogen gas is produced during leaching, and wherein the method further comprises recycling the hydrogen gas to the reducing atmosphere used during reducing iron in a subsequent batch of green pellets.
Clause 25: The method of claim 1, further comprising recovering the iron that was removed by leaching.
Clause 26: The method of claim 1, further comprising pre-oxidizing iron(II) in the green pellets to iron(III) before the reducing.
Clause 27: The method of claim 1, wherein the upgraded synthetic rutile comprises titanium dioxide in an amount greater than 88 wt %.
Clause 28: The method of claim 1, wherein the upgraded synthetic rutile comprises rutile, anatase, or a combination thereof.
Clause 29: The method of claim 1, wherein the upgraded synthetic rutile has an average particle size from about 75 μm to about 1500 μm, and optionally from 100 μm to 1000 μm.
Clause 30: The method of claim 1, wherein the upgraded synthetic rutile has a porosity of 5 to 20% by volume.
Clause 31: The method of claim 1, further comprising using the synthetic rutile as a feedstock in a fluidized bed.
Clause 32: The method of claim 31, wherein the fluidized bed is used in a chloride process of purifying titanium dioxide.
Clause 33: An upgraded synthetic titanium dioxide pellet, comprising a plurality of partially sintered together ultrafine particles, wherein the ultrafine particles have an average particle size from about 0.1 μm to about 50 μm, wherein void spaces are present between at least some of the partially sintered together ultrafine particles, and wherein the upgraded synthetic titanium dioxide pellet has a diameter from about 75 μm to about 1500 μm, and optionally from 100 μm to 1000 μm.
Clause 34: The upgraded synthetic titanium dioxide pellet of claim 33, wherein the upgraded synthetic titanium dioxide pellet comprises titanium dioxide in an amount greater than 88 wt %.
Clause 35: The upgraded synthetic titanium dioxide pellet of claim 33, wherein the upgraded synthetic titanium dioxide pellet has a porosity of 5-50%.
Clause 36: The upgraded synthetic titanium dioxide pellet of claim 33, wherein the upgraded synthetic titanium dioxide pellet is free of inorganic binder.

What is claimed is:

1. A method of making upgraded synthetic rutile, comprising:
binding ilmenite ultrafine titanium-containing particles together with an optional binder to form green pellets;
reducing iron in the green pellets by heating the green pellets to a reducing temperature under a reducing atmosphere;
at least partially sintering together the ilmenite ultrafine titanium-containing particles within the green pellets by heating the green pellets at a sintering temperature to form at least partially sintered pellets; and
removing iron from the at least partially sintered pellets by leaching to form upgraded synthetic rutile.

2. The method of claim 1, further comprising forming the ilmenite ultrafine titanium-containing particles by milling ilmenite ore.

3. The method of claim 1, wherein the ilmenite ultrafine titanium-containing particles have an average particle size from about 0.1 micrometer to about 50 micrometers.

4. The method of claim 1, wherein the ilmenite ultrafine titanium-containing particles include titanium dioxide in an amount from about 40 wt % to about 65 wt % and iron in an amount from about 15 wt % to about 31 wt %.

5. The method of claim 1, wherein the optional binder is present and is an organic binder.

6. The method of claim 5, wherein the organic binder comprises polyethylene, polypropylene, polyethylene glycol, polyvinylpyrrolidone, polyoxymethylene, polylactic acid, nylon, hyaluronate, cellulose, starches, or a combination thereof.

7. The method of claim 5, wherein binding the ilmenite ultrafine titanium-containing particles together comprises spraying a solution of the organic binder while tumbling the ultrafine ilmenite titanium-containing particles in a rotating vessel.

8. The method of claim 7, wherein the solution of the organic binder includes the organic binder dissolved in a solvent comprising ethanol, methanol, water, or a combination thereof.

9. The method of claim 7, wherein a concentration of organic binder in the solution is from about 0.1 wt % to about 5 wt %.

10. The method of claim 5, wherein the organic binder is vaporized or decomposed during the heating the green pellets to the reducing temperature.

11. The method of claim 5, wherein no carbon is added to the ilmenite ultrafine titanium-containing particles when forming the green pellets other than the organic binder.

12. The method of claim 1, wherein the green pellets have an average particle size from about 75 μm to about 1500 μm.

13. The method of claim 1, wherein the reducing temperature is from about 400° C. to about 1000° C.

14. The method of claim 1, wherein reducing the iron in the green pellets comprises holding the green pellets at the reducing temperature for a reducing time from about 0.1 hours to about 16 hours.

15. The method of claim 1, wherein the reducing atmosphere is hydrogen gas.

16. The method of claim 1, wherein the at least partially sintering is performed under the reducing atmosphere.

17. The method of claim 1, wherein the sintering temperature is greater than the reducing temperature.

18. The method of claim 17, wherein the green pellets are heated from the reducing temperature to the sintering temperature without cooling the green pellets below the reducing temperature in between.

19. The method of claim 17, wherein the green pellets are heated to the sintering temperature after letting the green pellets cool below the reducing temperature.

20. The method of claim 1, wherein the sintering temperature is from about 900° C. to about 1500° C.

21. The method of claim 1, wherein the at least partially sintering comprises holding the green pellets at the sintering temperature for a sintering time from about 10 minutes to about 2 hours.

22. The method of claim 1, wherein the at least partially sintering is partially sintering the ilmenite ultrafine titanium-containing particles so that at least some void space between the ilmenite ultrafine titanium-containing particles remains in the at least partially sintered pellets.

23. The method of claim 1, wherein leaching includes dissolving the iron with hydrochloric acid, sulfuric acid, or by aeration with ammonium chloride.

24. The method of claim 23, wherein hydrogen gas is produced during leaching, and wherein the method further comprises recycling the hydrogen gas to the reducing atmosphere used during reducing iron in a subsequent batch of green pellets.

25. The method of claim 1, further comprising recovering the iron that was removed by leaching.

26. The method of claim 1, further comprising pre-oxidizing iron(II) in the green pellets to iron(III) before the reducing.

27. The method of claim 1, wherein the upgraded synthetic rutile comprises titanium dioxide in an amount greater than 88 wt %.

28. The method of claim 1, wherein the upgraded synthetic rutile comprises rutile, anatase, or a combination thereof.

29. The method of claim 1, wherein the upgraded synthetic rutile has an average particle size from about 100 μm to about 1000 μm.

30. The method of claim 1, wherein the upgraded synthetic rutile has a porosity of 5 to 20% by volume.

31. The method of claim 1, further comprising using the upgraded synthetic rutile as a feedstock in a fluidized bed.

32. The method of claim 31, wherein the fluidized bed is used in a chloride process of purifying titanium dioxide.

33. An upgraded synthetic titanium dioxide pellet, comprising a plurality of partially sintered together ultrafine particles, wherein the ultrafine particles have an average particle size from about 0.1 micrometer to about 10 micrometers, wherein void spaces are present between at least some of the partially sintered together ultrafine particles, and wherein the upgraded synthetic titanium dioxide pellet has a diameter from about 100 μm to about 1000 μm.

34. The upgraded synthetic titanium dioxide pellet of claim 33, wherein the upgraded synthetic titanium dioxide pellet comprises titanium dioxide in an amount greater than 88 wt %.

35. The upgraded synthetic titanium dioxide pellet of claim 33, wherein the upgraded synthetic titanium dioxide pellet has a porosity of 5-50%.

36. The upgraded synthetic titanium dioxide pellet of claim 33, wherein the upgraded synthetic titanium dioxide pellet is free of inorganic binder.
